(19) United States
(12) Patent Application Publication
(10) Pub. No.: US 2013/0119994 A1
(43) Pub. Date: May 16, 2013

(54) APPARATUS, SYSTEM AND METHOD FOR ESTIMATING A PROPERTY OF A DOWNHOLE FLUID

(71) Applicant: Sebastian Csutak, Houston, TX (US)

(72) Inventor: Sebastian Csutak, Houston, TX (US)

(73) Assignee: Baker Hughes Incorporated, Houston, TX (US)

(21) Appl. No.: 13/293,938

(22) Filed: Nov. 10, 2011

(51) Int. Cl. G01V 3/12

(52) U.S. Cl. 324/338

(57) ABSTRACT

An apparatus is disclosed for estimating a property of a downhole fluid, the apparatus including but not limited to a test cell that receives the downhole fluid; a swept frequency electromagnetic energy source that emits electromagnetic energy toward the downhole fluid in the test cell; an electromagnetic/mechanical device that is immersed in the fluid and receives the emitted electromagnetic energy, wherein the emitted electromagnetic energy being emitted is swept about a resonant frequency for the electromagnetic/mechanical device; and an electromagnetic energy detector in electromagnetic communication with the electromagnetic/mechanical device immersed in the fluid, the electromagnetic energy detector producing an output signal indicative of the downhole fluid property. A system and method for estimating a property of a downhole fluid are also disclosed.

### CROSS REFERENCE TO RELATED APPLICATIONS

None

### BACKGROUND

1. Technical Field

The present invention relates to using density and viscosity measurements of a liquid sample from a hydrocarbon bearing formation to determine whether the formation will produce fluid that is valuable enough to justify the cost of production

2. Related Information

As the availability of hydrocarbon deposits in the earth diminish, the cost of obtaining these hydrocarbons from the earth increases. Thus, as the cost increases the economic and social benefit increases for improved products and methods useful for planning when and where to feasibly pursue hydrocarbon production of a reservoir. A particular hydrocarbon reservoir may contain several hydrocarbon bearing formations. These reservoir formations may or may not be connected.

The cost and difficulty of producing or producibility of earth borne hydrocarbons from a reservoir is related to the permeability of the hydrocarbon reservoir or formation in the earth. The producibility, that is, the difficulty and associated costs of obtaining these earth borne hydrocarbons can be determined by testing samples of hydrocarbons from a particular formation. The producibility of a formation is related to the density and viscosity of a hydrocarbon formation fluid sample taken from the formation.

### SUMMARY OF THE DISCLOSURE

An apparatus is disclosed for estimating a property of a downhole fluid, the apparatus including but not limited to a test cell that receives the downhole fluid; a swept frequency electromagnetic energy source that emits electromagnetic energy toward the downhole fluid in the test cell; an electromagnetic/mechanical device that is immersed in the fluid and receives the emitted electromagnetic energy, wherein the emitted electromagnetic energy being emitted is swept about a resonant frequency for the electromagnetic/mechanical device; and an electromagnetic energy detector in electromagnetic communication with the electromagnetic/mechanical device immersed in the fluid, the electromagnetic energy detector producing an output signal indicative of the downhole fluid property. A system and method for estimating a property of a downhole fluid are also disclosed.

### BRIEF DESCRIPTION OF THE DRAWINGS

FIG. 1 is a schematic diagram of a particular illustrative embodiment deployed on a wire line in a downhole environment;

FIG. 2 is a schematic diagram of another particular illustrative embodiment deployed on a drill string in a monitoring while drilling environment; and

FIG. 3 is a schematic diagram of a particular illustrative embodiment illustrating an electromagnetic/mechanical system as deployed in a down hole fluid for estimating density and viscosity of a downhole fluid;

FIG. 4 is a graphical plot of a normalized detuning curve about a resonant of an optomechanical device deployed in a down hole fluid for estimating density of a downhole fluid;

FIG. 5 is a graphical plot of a amplitude versus swept frequency for an illustrative embodiment of an optomechanical device deployed in a down hole fluid for estimating density of a downhole fluid;

FIG. 6 is a schematic diagram of another particular illustrative embodiment of an optomechanical device for estimating density of a downhole fluid;

FIG. 7 is a schematic diagram of another particular illustrative embodiment of an optomechanical device for estimating density of a downhole fluid; and

FIG. 8 is a schematic diagram of another particular illustrative embodiment illustrating an optomechanical device for deployment in a downhole fluid for estimating density of a downhole fluid.

### DETAILED DESCRIPTION OF ILLUSTRATIVE EMBODIMENTS

### Detailed Description

The present disclosure uses terms, the meaning of which terms will aid in providing an understanding of the discussion herein. As used herein, high temperature refers to a range of temperatures typically experienced in oil production well boreholes. For the purposes of the present disclosure, high temperature and downhole temperature include a range of temperatures from about 100 degrees C. (212 degrees F.) to about 200 degrees C. (392 degrees F.) and above.

The term “carrier” as used herein means any device, device, component, combination of devices, media and/or member that may be used to convey, house, support or otherwise facilitate the use of another device, device component, combination of devices, media and/or member. Exemplary non-limiting carriers include wire lines and drill strings of the coiled tube type, of the jointed pipe type and any combination or portion thereof.

A “downhole fluid” as used herein includes any gas, liquid, flowable solid and other materials having a fluid property. A downhole fluid may be natural or man-made and may be transported downhole or may be recovered from a downhole location. Non-limiting examples of downhole fluids include but are not limited to drilling fluids, return fluids, formation fluids, production fluids containing one or more hydrocarbons, oils and solvents used in conjunction with downhole tools, water, brine and combinations thereof.

“Processor” as used herein means any device that transmits, receives, manipulates, converts, calculates, modulates, transposes, carries, stores or otherwise utilizes well information and electromagnetic information, discussed below. In several non-limiting aspects of the disclosure, a processor includes but is not limited to a computer that executes programmed instructions stored on a tangible non-transitory computer readable medium for performing various methods.

Portions of the present disclosure, detailed description and claims may be presented in terms of logic, software or software implemented illustrative embodiments that are encoded on a variety of tangible non-transitory computer readable storage media including, but not limited to tangible non-transitory machine readable media, program storage media or computer program products. Such media may be handled, read, sensed and/or interpreted by an information processing device. Those skilled in the art will appreciate that such media may take various forms such as cards, tapes, magnetic disks (e.g., floppy disk or hard disk drive) and optical disks (e.g., compact disk read only memory (“CD-ROM”) or digital versatile (or video) disk (“DVD”)). Any embodiment disclosed herein is for illustration only and not by way of limiting the scope of the disclosure or claims.

The present invention uses energy from electromagnetic spectrum to estimate density and viscosity of a downhole fluid. The electromagnetic spectrum includes, from longest wavelength to shortest: radio waves, microwaves, infrared, visible, ultraviolet, X-rays, and gamma-rays. Devices that respond mechanically to electromagnetic radiation are referred to herein as electromagnetic/mechanical devices. The concept that electromagnetic radiation can exert forces on material objects was predicted by Maxwell, and the radiation pressure of electromagnetic energy was first observed experimentally more than a century ago. The force F exerted by a beam of power P retro reflecting from a mirror is F=2P/c. Because the speed of electromagnetic energy is so large, this force is typically extremely feeble but does manifest itself in special circumstances (e.g., in the tails of comets and during star formation). Beginning in the 1970s, researchers were able to trap and manipulate small particles and even individual atoms with optical forces.

An optomechanical device, which responds to the visible electromagnetic spectrum, is one type of electromechanical device that is used to estimate density of a downhole fluid. One particular optomechanical system includes but is not limited to an optical cavity where one of the end-mirrors can move. The application of radiation forces to manipulate the center-of-mass motion of mechanical oscillators covers a range of scales from macroscopic mirrors to nanomechanical or micromechanical cantilevers vibrating microtoroids, and membranes.

When the cavity is illuminated by a laser emitting electromagnetic energy, the circulating electromagnetic energy gives rise to a radiation pressure force that deflects the movable mirror. Any displacement of the mirror will, in turn, change the cavity's length, shifting the optical cavity mode frequency with respect to the fixed laser frequency, and thereby alter intensity (amplitude) of electromagnetic energy circulating in the cavity. When the optomechanical device is immersed in a fluid, sweeping around a resonant frequency for the optomechanical device enables determination of density and viscosity for the fluid in which the optomechanical device is immersed. A swept resonant frequency/intensity (amplitude) curve is generated over the swept frequency, from which density and viscosity of the fluid in which the optomechanical device is immersed can be determined. Various illustrative embodiments of an optomechanical device can be realized, including but not limited to cantilevers or nanobeams as mechanical elements. Mass of devices according to several non-limiting devices may range from 10⁻¹⁵ to 10⁻¹⁰ kg (and even 1 g), while frequencies are often in the MHz regime (ωₘ/2π=1 kHz to 100 MHz). Electromagnetic energy can be reflected from Bragg mirrors made from multi-layered dielectric materials.

In another particular embodiment, an optomechanical device is disclosed that is based on microtoroid optomechanical device made from silica on a chip. A preferred embodiment uses electromagnetic energy circulating inside an optical whispering gallery mode inside the microtoroid which exerts a radiation pressure that couples to a mechanical breathing mode. Preferable optomechanical devices include a high optical finesse (currently in the range from 10³ to 10⁵) and a high mechanical quality factor or Q (10³ to 10⁵ for beams and cantilevers). In another embodiment, a membrane with a thickness of about 50 nm inside a fixed optical cavity can be provided to obtain both of these goals to some degree and exceed them by achieving a finesse of 10⁴ and a mechanical quality factor of 10⁶. In physics and engineering the quality factor, referred to as the Q factor is a dimensionless parameter that describes how under-damped an oscillator or resonator is, or equivalently, characterizes a resonator's bandwidth relative to its center frequency. Higher Q indicates a lower rate of energy loss relative to the stored energy of the oscillator; the oscillations die out more slowly. A pendulum suspended from a high-quality bearing, oscillating in air, has a high Q, while a pendulum immersed in oil has a low one. Oscillators with high quality factors have low damping so that they ring longer. The optical Q is equal to the ratio of the resonant frequency to the bandwidth of the cavity resonance. The average lifetime of a resonant photon in the cavity is proportional to the cavity's Q.

An illustrative embodiment is disclosed in which an optomechanical device is immersed in a downhole fluid to measure density and viscosity of the downhole fluid. In a particular non-limiting illustrative embodiment, the optomechanical device has a toroidal shape. The optomechanical device provides optomechanical feed back due to radiation pressure created by a laser emitting electromagnetic energy into the optomechanical device. In another embodiment, the optomechanical device is a zipper cavity. In another particular embodiment, the Q of the optical cavity is about 1,000,000. A change in the optomechanical properties of the optomechanical device is converted into the optical domain. In a particular embodiment, electromagnetic energy is evanescently coupled into and from the optomechanical device using a waveguide. Electromagnetic energy evanescently coupled from the waveguide is measured to estimate density and viscosity of the downhole fluid in which the optomechanical device is immersed. Density and viscosity are estimated by correlating shifts in optical domain, including but not limited to a transmission/reflection wavelength in an optical cavity in the optomechanical device during frequency sweeps about a resonant frequency for an optical cavity in the optomechanical device. In a particular embodiment a first frequency and second frequency of electromagnetic energy are coupled into the optomechanical resonator. The first frequency is swept around a resonant frequency for the optomechanical device and the second frequency is monitored for amplitude during the frequency sweep to estimate density and viscosity for a downhole fluid.

Optomechanical devices can be manufactured in many geometric shapes including but not limited to a toroid, sphere, rectangle, zipper and square. In a particular non limiting embodiment the electromagnetic/mechanical device can be but is not limited to a whispering gallery microtoroid optomechanical device. In another particular embodiment, the optomechanical device is any shape in accordance with the disclosure that is suitable for manifesting an optomechanical reaction to electromagnetic energy input to the optomechanical device shape.

Preferably the resonant frequency for the electromagnetic/mechanical device is low enough so that excitation of the electromagnetic/mechanical device in the fluid enables the fluid in which the electromagnetic/mechanical device is immersed, to behave as a Newtonian fluid. Newtonian fluid behavior enables substantially accurate determination of density and viscosity from monitoring test electromagnetic energy from the electromagnetic/mechanical device during sweeping about a resonant frequency of the electromagnetic/mechanical device from electromagnetic energy introduced into the optomechanical device.

A non-limiting example of an optomechanical device as an example of an electromagnetic/mechanical device is used herein for purposes of illustration. Any electromagnetic/mechanical device, including but not limited to devices that respond to radio waves, microwaves, infrared, visible, ultraviolet, X-rays, and gamma-rays in accordance with the present disclosure are acceptable.

The wavelength of a resonant frequency of a particular optomechanical device is proportional to the size of an optical cavity in the device. For example, an optical cavity having a length of 1 micron has a resonant frequency of about 1 MHz. An optical cavity having a length of 10 microns has a resonant frequency of about a 100 KHz. An optical cavity having a length of 100 microns has a resonant frequency of about a 10 KHz. The frequency of electromagnetic energy input to an optomechanical device, such as a microtoroid or other electromagnetic/mechanical device is swept about a resonant frequency for a particular electromagnetic/mechanical device. In a preferred embodiment, the resonant frequency for the electromagnetic/mechanical device is about 20-50 KHz.

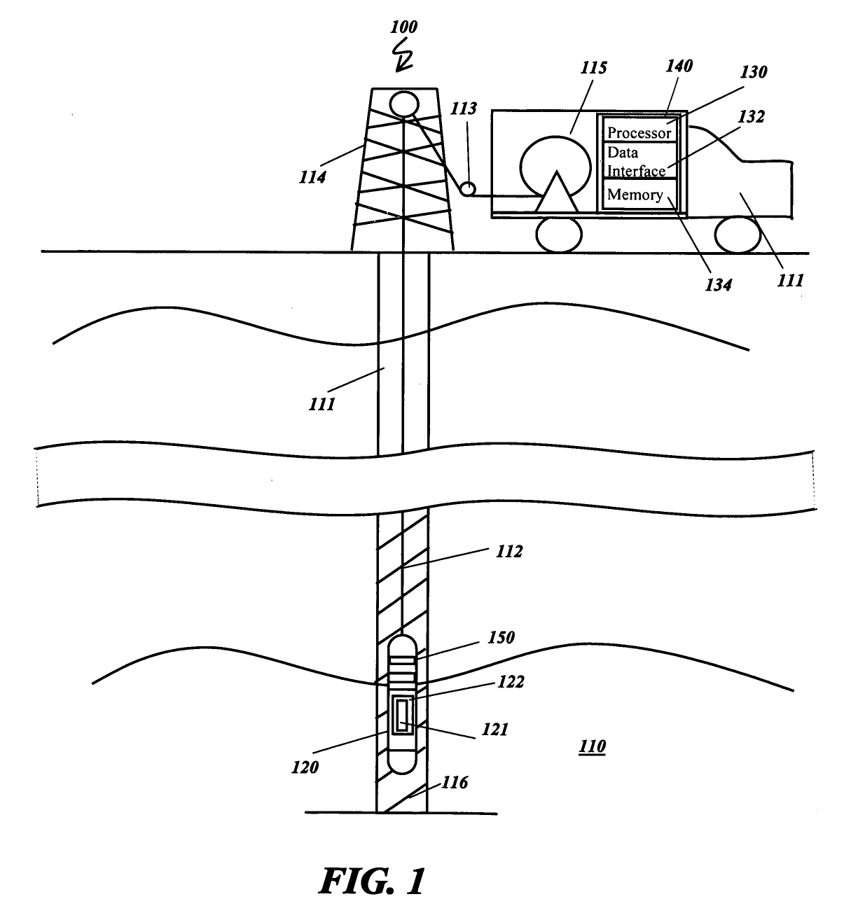

A particular illustrative embodiment additionally provides, based on density and viscosity calculations derived from monitoring electromagnetic energy from an electromagnetic/mechanical device, a system and method for monitoring cleanup from a leveling off of viscosity or density over time; measuring or estimating bubble point for formation fluid or filtrate; measuring or estimating dew point for formation fluid or filtrate; and the onset of asphaltene precipitation. Each of these applications of particular illustrative embodiments contributes to the commercial value of downhole monitoring tools, while drilling tools, and wire line tools. Non-limiting examples of the structure and operation of the present invention are discussed below in connection with FIG. 1-8.

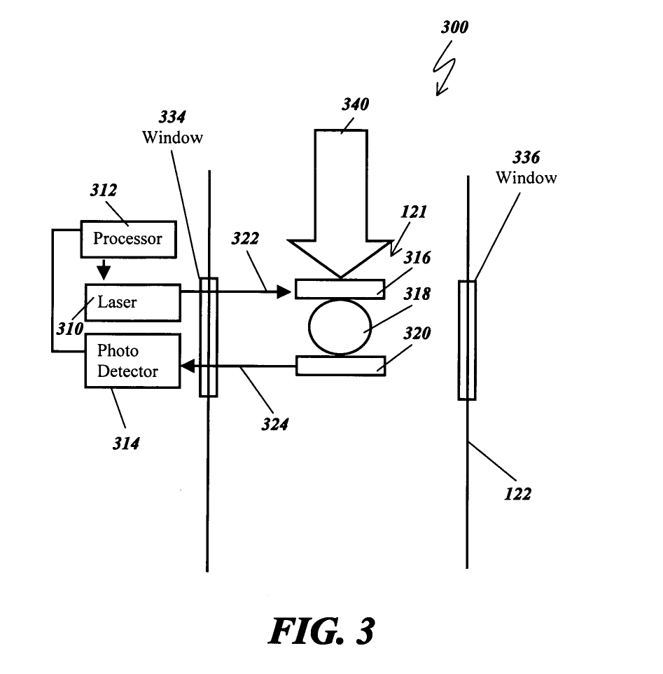

FIG. 1 is a schematic representation of a wireline formation testing system 100 for estimating a property of a downhole fluid. FIG. 1 shows a wellbore 111 drilled in a formation 110. The wellbore 111 is shown filled with a drilling fluid 116, which is also is referred to as “mud” or “wellbore fluid.” The term “connate fluid” or “natural fluid” herein refers to the fluid that is naturally present in the formation, exclusive of any contamination by the fluids not naturally present in the formation, such as the drilling fluid. Conveyed into the wellbore 111 at the bottom end of a wireline 112 is a formation evaluation tool 120 that includes but is not limited to an analysis module 150 and an electromagnetic/mechanical system 121 made according to one or more embodiments of the present disclosure for in-situ estimation of a property of the fluid withdrawn from the formation. The formation evaluation tool 120 acts a carrier for the electromagnetic/mechanical system 121 and a test cell 122: Exemplary embodiments of various formation evaluation tools are described in more detail in reference to FIGS. 3-8. The wireline 112 typically is an armored cable that carries data and power conductors for providing power to the tool 120 and a two-way data communication link between a tool processor in the analysis module 150 and a surface controller 140 placed in surface unit, which may be a mobile unit 111, such as a logging truck. The surface controller and analysis module 150 each included but are not limited to a processor 130, data interface 132 and non-transitory computer readable media 134.

The wireline 112 typically is carried from a spool 115 over a pulley 113 supported by a derrick 114. The controller 140 and analysis module 150 are each in one aspect, a computer-based system, which may include one or more processors such a microprocessor, that may include but is not limited to one or more non-transitory data storage devices, such as solid state memory devices, hard-drives, magnetic tapes, etc.; peripherals, such as data input devices and display devices; and other circuitry for controlling and processing data received from the tool 120. The surface controller 140 and analysis module 150 may also include but is not limited to one or more computer programs, algorithms, and computer models, which may be embedded in the non-transitory computer-readable medium that is accessible to the processor for executing instructions and information contained therein to perform one or more functions or methods associated with the operation of the formation evaluation tool 120.

The test cell 122 may include but is not limited to a downhole fluid sample tank and a flow line 211 for downhole fluid to flow into the sample tank. At least a portion of the electromagnetic/mechanical system 121 is immersed in the downhole fluid in the test cell 122 and used for in situ or surface analysis of the downhole fluid, including but not limited to estimating viscosity and density of the downhole fluid. The test cell may be any suitable downhole fluid test cell in accordance with the disclosure. Non-limiting examples of a test cell include but are not limited to a downhole fluid sample chamber and a downhole fluid flow line. Additional downhole test device for estimating a property of the downhole fluid may be included in the formation evaluation tool 120, any test device may be included in accordance with disclosure, including but not limited to nuclear magnetic resonance (NMR) spectrometers, pressure, temperature and electromechanical resonators, such as electrically drive piezoelectric resonators.

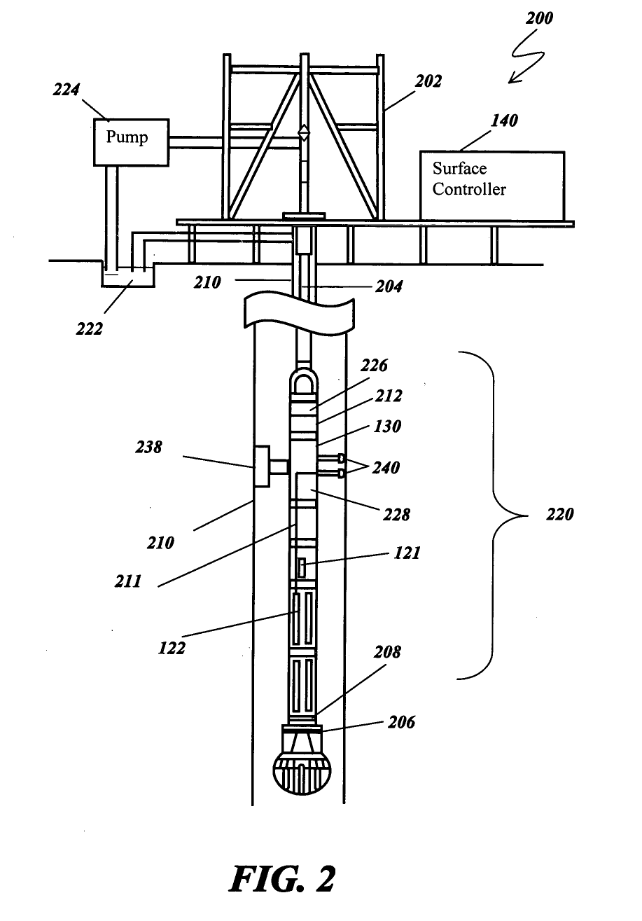

FIG. 2 depicts a non-limiting example of a drilling system 200 in a measurement-while-drilling (MWD) arrangement according to one embodiment of the disclosure. A derrick 202 supports a drill string 204, which may be a coiled tube or drill pipe. The drill string 204 may carry a bottom hole assembly (BHA) 220 and a drill bit 206 at a distal end of the drill string 204 for drilling a borehole 210 through earth formations. Drilling operations according to several embodiments may include pumping drilling fluid or “mud” from a mud pit 222, and using a circulation system 224, circulating the mud through an inner bore of the drill string 204. The mud exits the drill string 204 at the drill bit 206 and returns to the surface through an annular space between the drill string 204 and inner wall of the borehole 210.

In the non-limiting embodiment of FIG. 2, the BHA 220 may include a formation evaluation tool 120, a power unit 226, a tool processor 212 and a surface controller 140. Any suitable power unit may be used in accordance with the disclosure. Non-limiting examples of suitable power units include but are not limited to a hydraulic, electrical, or electro-mechanical and combinations thereof. The tool 120 may carry a fluid extractor 228 including a probe 238 and opposing feet 240. In several embodiments to be described in further detail below, the tool 120 includes but is not limited to a downhole electromagnetic/mechanical system 121. A flow line 211 connects fluid extractor 228 to test cell 122 and electromagnetic/mechanical system 121. The electromagnetic/mechanical system may be used in either the while-drilling embodiments or in the wireline embodiments for in situ or surface estimation of a property of the downhole fluid.

Those skilled in the art with the benefit of the present disclosure will recognize that the several embodiments disclosed are applicable to a formation fluid production facility without the need for further illustration. The several examples described below and shown in FIG. 3-8 may be implemented using a wireline system as described above and shown in FIG. 1, may be implemented using a while-drilling system as described above and shown in FIG. 2 or may be implemented in a production facility to monitor production fluids.

Turning now to FIG. 3, a particular illustrative embodiment of an optomechanical system 121 is illustrated. Optomechanical device 318 is immersed in downhole fluid 340 in test cell 122. In an illustrative embodiment, a laser 310 provides electromagnetic energy 322 to the optomechanical device 318 in test cell 122. The electromagnetic energy is swept about a resonant frequency for an optical cavity in the optomechanical device. Windows 334 and 336 are provided for ingress and egress of electromagnetic energy into and from the test cell 122. A photodetector 314 is provided electromagnetic communication with the optomechanical device for measuring electromagnetic energy 324 received from the test cell through window 322. One or both of the photodetector 314 and laser 310 can also be located outside of test cell window 336 and in electromagnetic communication with optomechanical device 318. A processor 312 including but not limited to a non-tangible computer readable medium and computer programs stored in the non-tangible computer readable medium is also provided. Electromagnetic energy 322 is received by waveguide 316 and is evanescently coupled into the optomechanical device 318. Waveguide 320 evanescently couples electromagnetic energy 324 is evanescently coupled out of the optical device 318.

Operation of the structure shown in FIGS. 1-3 is now discussed. The processor 312 executes the computer programs. The computer programs include but are not limited to computer executable instructions that when executed by the processor control the structure of FIG. 3 and perform methods for estimating a property of the downhole fluid in test cell 122. The processor sweeps the frequency of electromagnetic energy 322 emitted from laser 310 centered on a resonant frequency for the optomechanical device 318. The wave guide 316 receives electromagnetic energy 322 introduced into the test cell 122 by the laser. In a particular embodiment, the electromagnetic energy is evanescently coupled from the wave guide into optomechanical device 318. Any suitable coupling of electromagnetic energy into the optomechanical device 318 in accordance with the present disclosure is acceptable. One non-limiting example of an evanescent coupling is a Si₃N₄ seal between the wave guide and the optical cavity. Electromagnetic energy 324 from the optomechanical device is evanescently coupled from the optomechanical device into wave guide 320.

In another particular embodiment, a single wave guide is used to receive electromagnetic energy and couple it into the optomechanical device and receive energy from the optomechanical device via coupling. A photodetector 314 receives electromagnetic energy 324 from wave guide 320 through window 334. The processor reads the photodetector amplitude measurements of electromagnetic energy 324 received from the optomechanical device as the processor sweeps the frequency of electromagnetic energy 322 emitted from laser about a resonant frequency for the optomechanical device 318. The electromagnetic/mechanical device is immersed in downhole fluid 340. The processor 312 may further include a tangible non transitory computer readable storage media for containing data and computer programs used in estimating the density and viscosity of the downhole fluid.

A preferred optomechanical device resonates at a frequency that enables the downhole fluid in which the optomechanical device is immersed in the fluid, to behave as a Newtonian fluid at the resonant frequency of the optomechanical device. A sample of formation fluid or another downhole fluid 340 is captured in the test cell 122 in the tool. A swept frequency of input electromagnetic energy 322 from the laser is introduced into test cell 332 through a first window 334 in the sample chamber. Photo detector 314 measures test electromagnetic energy 324 received from the optomechanical device through window 334. The photo detector measures electromagnetic energy received from the optomechanical device as the electromagnetic energy is swept frequency over a range of frequencies centered about a resonant frequency for an optical cavity in the optomechanical device.

The processor 312 forms a spectrum of the optomechanical device's response in the downhole fluid 340 to the input swept frequency of electromagnetic energy to determine density and viscosity of the downhole fluid in which the optomechanical device is immersed. Monitoring the electromagnetic energy 324 decoupled from the optomechanical device enables the processor to correlate the swept frequency with mechanical motion in the optomechanical device indicated by changes in the electromagnetic energy received from the optomechanical device. The photodetector 314 and laser and can also be placed outside of second window 336 to allow ingress and egress of electromagnetic energy to and from test cell 122 through second window 336.

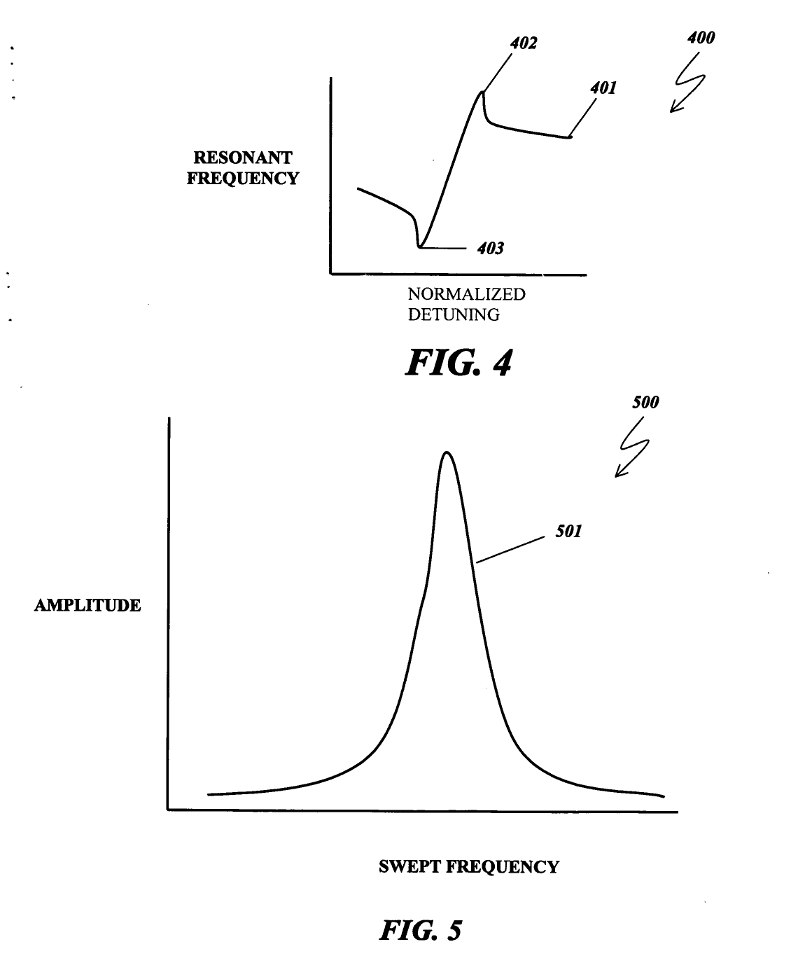

In a particular embodiment, a fibre based Mach-Zehnder interferometer (not shown) is used to convert sweep time to wavelength for swept laser frequency measurements in conjunction with a non-linear model for the optomechanical force and laser-cavity detuning in the optomechanical device. The photodetector measurements of amplitude of electromagnetic energy received from the optomechanical device are used by the processor to determine an amplitude versus frequency curve for the received electromagnetic energy as the electromagnetic energy is swept around the resonant frequency for the optomechanical device. Example of curves generated from the amplitude measurements versus the swept frequency are shown below in FIG. 4 and FIG. 5.

The resonance curve is analyzed to estimate density and viscosity for the fluid in which the optomechanical device is immersed. The optomechanical device has the advantage of not having to be physically or electrically connected to excitation or monitoring circuitry on the outside of chamber 122. Instead the optomechanical device is optically driven by swept laser electromagnetic energy 322 through window 334 and output electromagnetic energy 324 optically monitored via photodetector 314 as the output electromagnetic energy 324 exits chamber 332 through window 334. In a particular illustrative embodiment, laser 310 provides a carrier frequency of approximately 20 terra hertz and is swept over a frequency band of approximately 20 kilohertz.

Turning now to FIG. 4, FIG. 4 depicts sample spectroscopic scans a particular illustrative embodiment of an optomechanical spectrometric device. FIG. 4 is a graph illustrating a resonant frequency versus normalized detuning curve 401 in another particular illustrative embodiment illustrating operation and use of an optomechanical device deployed in a downhole fluid for determining a density of the fluid downhole. A maximum 402 and minimum 403 as well as a zero crossing point 404 are used to correlate with test curves for known downhole fluids to estimate density and viscosity of the downhole fluid in test cell 122.

FIG. 5 is a graph of amplitude versus swept frequency curve 501 in another particular illustrative embodiment illustrating operation and use of an optomechanical device deployed in a downhole fluid for determining a density of the fluid downhole. Density and viscosity of the fluid is calculated from the value of points on the resonant frequency curves tracked by the processor. The present example of the invention is implemented using an optomechanical device downhole to estimate fluid density, viscosity, dielectric constant, and resistivity. The present invention measures the amplitude versus frequency (amplitude spectrum) for an optomechanical device in the vicinity of its resonant frequency.

To convert this measurement to density, viscosity, dielectric constant and resistivity, the present invention determines a best fit between a theoretical spectrum and the measured amplitude spectrum for the optomechanical device, using a Levenberg-Marquardt (LM) nonlinear least squares fit algorithm. The fitting parameters provide density, viscosity, dielectric constant and resistivity values. If the initial parameter value estimates for the fitting parameters are too far from the actual parameter values, the LM fitting algorithm may take a long time to converge or may fail to converge entirely. Even if the LM algorithm does converge, it may converge to a local minimum rather than a global minimum. When logging a well in real time, the operator does not want to wait a long time for an answer nor does the operator want the algorithm to converge to the wrong answer at a local rather than a global minimum.

The present invention computes a result quickly, uses less computing resources and thus provides more useful and accurate initial estimates for the LM fitting parameters. The initial estimates provided by the present invention are robust, they do not require iteration, and they are quickly computed. The present invention uses chemometrics to obtain the initial estimates of fitting parameters. These chemometric estimations can then be used directly as estimates of a fluid parameter value or property or provided to the LM algorithm. The chemometric estimations provided to the LM algorithm provide a high probability of allowing the LM algorithm to converge quickly to the correct global minimum for the downhole fluid property value estimation.

Traditional chemometrics can be defined as multiple linear regressions (MLR), principle components regressions (PCR), or partial least squares (PLS). Chemometrics can be applied either to an original data set or to a preprocessed version of the original data such as a Savitzky-Golay (SG) smoothed curve or its derivatives. When using these traditional chemometric techniques, the property-prediction equation is usually just an offset constant plus the dot product of a weights vector with the measured optomechanical amplitude spectrum. This calculation requires a relatively small amount of computer time as the calculation is non-iterative. However, chemometric equations can also be based on minimum, maximum, or zero-crossing values or other similarly derived properties of the data as shown in FIG. 4 and FIG. 5. In some cases, the chemometric predictions or the fits to the synthetic data are sufficiently accurate to use directly without going to the second step of applying a LM fitting algorithm.

When a chemometric equation is available, applying it is both quicker and simpler than an iterative approach. In this example, the X and Y values of the lowest experimental data point are P₂ and P₃, respectively, and P₁ simply equals one-half of the second derivatives of these data points. Because the data points are evenly spaced along the X-axis, a 5-consecutive-point numerical second derivative can be obtained by standard Savitzky-Golay methods (A. Savitzky and M. Golay, “Smoothing and Differentiation of Data by Simplified Least Squares Procedures,” Anal. Chem. vol. 36, No. 8, July, 1964, pp. 1627-1639). Then, P₁=(2xₘ₋₂−xₘ₋₁−2xₘ−xₘ₊₁ 2xₘ₊₂)/14, where xₘ₋₂ to 2xₘ₊₂ are five consecutive experimental data points, preferably ones near the minimum of the parabola where experimental error would have the least effect on the calculated value of P₁.

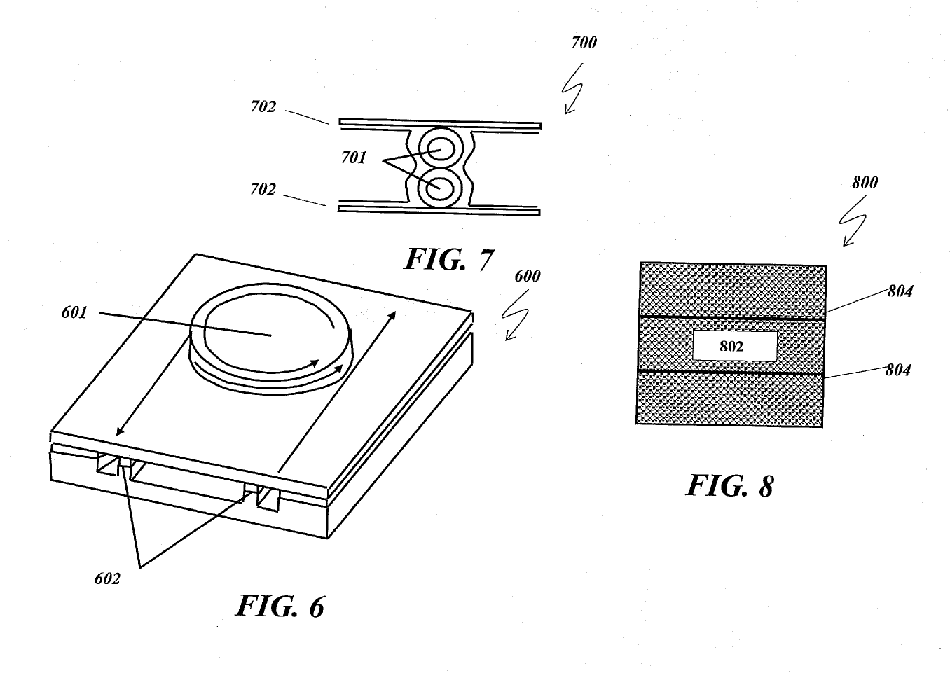

Turning now to FIG. 6, FIG. 6 is a schematic depiction of an optomechanical microtoroid or disk 601 whispering gallery in which two buried waveguides 602 are vertically coupled to the optomechanical disk. In a particular illustrative embodiment the optomechanical device is a waveguide etched on a silicon chip as shown in more detail in FIGS. 6-8. The waveguides lithographically form through a process of lithography and etching and then wafer bonding an initially mechanically separate, second wafer containing layers that ultimately become an optomechanical microresonator suitable for use as a microtoroid for estimating a property of a fluid.

FIG. 7 depicts an optomechanical disk array wherein two optomechanical disks 701 of different sizes and different resonant frequencies are integrated into a single wafer structure with wave guides 702. In an illustrative embodiment each of the two or more optomechanical disks can be swept at a different resonant frequency which enables density and viscosity measurements for a broader range of fluids that will exhibit Newtonian fluid behavior at the different resonant frequencies for each different optomechanical disk or microtoroid 701.

FIG. 8 is a schematic depiction of an illustrative embodiment of an optomechanical device having a rectangular optical cavity. As shown in FIG. 8, in a particular illustrative embodiment, the optomechanical device is a photonic crystal microcavity laser having a rectangular optical cavity 802 and wave guides 804. FIG. 8 schematically illustrates a cross section of the photonic crystal microcavity laser showing a defect region formed by an unetched hole in array of holes to form a defect in the array and a defection mode in the optical spectrum. The microcavity is formed by dry etching an array and a subsequent selective eth of an interior region, crating a thin membrane. On hole is left unetched creating a defect in the array and therefore a defect mode in the optical spectrum. The mode is confined to the interior of the array by Bragg reflection in the plane and conventional wave guiding in the vertical direction.

A resonance spectrum is developed for the optomechanical device that shows the resonance of the optomechanical device immersed in a fluid can be used to estimate the density and viscosity of the fluid. Samples are taken from the formation by pumping fluid from the formation into a sample cell. Filtrate from the borehole normally invades the formation and consequently is typically present in formation fluid when a sample is drawn from the formation. As formation fluid is pumped from the formation the amount of filtrate in the fluid pumped from the formation diminishes over time until the sample reaches its lowest level of contamination. This process of pumping to remove sample contamination is referred to as sample clean up.

In reality, the sample is rarely clean as typically downhole fluid is a mixture of formation fluid and drilling mud. Thus, downhole fluid sample clean up is considered complete when the viscosity or density has leveled off within the resolution of the estimation of the property of the downhole fluid of the tool for a selected period of time, for example, twenty minutes to one hour. A density or viscosity measurement is also compared to a historical measure of viscosity or density for a particular formation and or depth in determining when a sample is cleaned up.

The bubble point pressure for a sample is indicated by that pressure at which the measured viscosity for formation fluid sample decreases abruptly. The dew point is indicated by an abrupt increase in viscosity of a formation fluid sample in a gaseous state. The asphaltene precipitation pressure is that pressure at which the viscosity decreases abruptly. For purposes of this disclosure, an abrupt increase or decrease can be in but is not limited to the range of a 50-100% change in the rate of increase or decrease in a measurement. In another particular embodiment, the electromagnetic/mechanical device is used to measure density in an electrically conductive fluid, such as water.

In another particular illustrative embodiment a chemometric equation derived from a training set of known properties to estimate a property of the downhole fluid is provided. In another particular illustrative embodiment provides a neural network derived from a training set of known properties to estimate formation fluid parameters is provided. For example, from a measured viscosity, a chemometric equation can be used to estimate nuclear magnetic resonance (NMR) temporal properties T₁ and T₂ for a downhole fluid to improve NMR measurements made independently in the tool. The chemometric equation can be derived from a training set of samples for which the viscosity and NMR T₁ and T₂ are known.

In NMR spectroscopy the term relaxation describes several processes by which nuclear magnetization prepared in a non-equilibrium state return to the equilibrium distribution. In other words, relaxation describes how fast spins “forget” the direction in which they are oriented. The rates of this spin relaxation can be measured in both spectroscopy and imaging applications. Different physical processes are responsible for the relaxation of the components of the nuclear spin magnetization vector M parallel and perpendicular to the external magnetic field, B₀ (which is conventionally oriented along the z axis). These two principal relaxation processes are termed T₁ and T₂ relaxation respectively. The longitudinal (or spin-lattice) relaxation time T₁ is the decay constant for the recovery of the z component of the nuclear spin magnetization, towards its thermal equilibrium value. The transverse (or spin-spin) relaxation time T₂ is the decay constant for the component of M perpendicular to B₀. Transverse (or spin-spin) relaxation time T₂ is the decay constant for the component of M perpendicular to B₀.

Another particular illustrative embodiment provides density, viscosity, and other measured or derived information available from the tool of another particular illustrative embodiment to a processor or intelligent completion system (ICS) at the surface. The ICS is a system for the remote, intervention less actuation of downhole completion equipment has been developed to support the ongoing need for operators to lower costs and increase or preserve the value of the reservoir. These needs are particularly important in offshore environments where well intervention costs are significantly higher than those performed onshore.

In one particular embodiment, an apparatus is disclosed for estimating a property of a downhole fluid, the apparatus including but not limited to a test cell that receives the downhole fluid; a swept frequency electromagnetic energy source that emits electromagnetic energy toward the downhole fluid in the test cell; an electromagnetic/mechanical device that is immersed in the fluid and receives the emitted electromagnetic energy, wherein the emitted electromagnetic energy being emitted is swept about a resonant frequency for the electromagnetic/mechanical device; and an electromagnetic energy detector in electromagnetic communication with the electromagnetic/mechanical device immersed in the fluid, the electromagnetic energy detector producing an output signal indicative of the downhole fluid property. In another embodiment of the apparatus, the electromagnetic energy source is a laser, the electromagnetic/mechanical device is an optomechanical device and the electromagnetic energy detector is a photodetector, apparatus further including but not limited to a first wave guide in optical communication with the laser for coupling the laser electromagnetic energy into and out of the optomechanical device. In another embodiment of the apparatus, the apparatus further comprises but is not limited to a second wave guide in optical communication with photodetector for receiving electromagnetic energy from the optomechanical device, wherein the processor is configured to estimate the property of the fluid from an amplitude of electromagnetic energy received from the optomechanical device versus the swept frequency.

In another embodiment of the apparatus, the optomechanical device is selected from at least one of a microtoroid and a zipper cavity. In another embodiment of the apparatus, the swept frequency of electromagnetic energy emitted by the laser is substantially centered on a resonant frequency for the optomechanical device wherein the downhole fluid behaves as a Newtonian fluid. In another embodiment of the apparatus, the optomechanical device is fabricated in a size selected to resonate at the frequency for the optomechanical device wherein the downhole fluid behaves as a Newtonian fluid. In another embodiment of the apparatus, the property is selected from a group consisting of viscosity and density of the fluid. In another embodiment of the apparatus, the laser electromagnetic energy introduced into the electromechanical device further comprises a first and second frequency of electromagnetic energy, wherein the first frequency of electromagnetic energy is swept around the resonant frequency and the second frequency of electromagnetic energy is coupled the photodetector and analyzed determine the resonant spectrum optomechanical device. In another embodiment of the apparatus, the fluid is electrically conductive. In another embodiment of the apparatus, the laser and photodetector are located outside of the test cell, the apparatus further including but not limited to a window in a wall of the test for ingress and egress of the electromagnetic energy to and from the optomechanical device immersed in the fluid.

In another embodiment a method is disclosed, the method including but not limited to capturing downhole fluid in a test cell; immersing an electromagnetic/mechanical device in the downhole fluid in the test cell; introducing electromagnetic energy into the electromagnetic/mechanical device; sweeping the electromagnetic energy at a frequency range around a resonant frequency for the electromagnetic/mechanical device; measuring electromagnetic energy from the electromagnetic/mechanical device over the swept frequency range; determining resonance spectrum values for the electromagnetic/mechanical device over the swept frequency range; determining a first frequency for the swept frequency spectrum; determining a second frequency for the swept frequency spectrum; and estimating the Property for the downhole fluid from the first and second frequencies. In another embodiment of the method, the swept frequency spectrum further comprises measured electromagnetic energy amplitude values from the electromagnetic/mechanical device and the first frequency is a frequency at which a component of the swept frequency spectrum value is at a maximum and the second frequency is a frequency at which a component of the resonance spectrum value is at a maximum value.

In another embodiment of the method, the property of the fluid is selected from the group consisting of density and viscosity. In another embodiment of the method, the method further includes but is not limited to estimating the property of the fluid by comparing the first frequency and the second frequency to frequencies stored in a data structure wherein the data structure indicates the fluid properties associated with the first and second frequency.

In another illustrative embodiment, a system for estimating a property of a downhole fluid is disclosed, the system including but not limited to a carrier for transporting a test cell for capturing a downhole fluid; a plurality of test devices for analyzing the downhole fluid; an electromagnetic/mechanical device immersed in the downhole fluid; an electromagnetic energy source in electromagnetic communication with the electromagnetic/mechanical device; a processor for sweeping a frequency of electromagnetic energy about a resonant frequency for the electromagnetic/mechanical device; and a detector in electromagnetic communication with electromagnetic energy that has interacted with the electromagnetic/mechanical device immersed in the fluid.

In another embodiment of the system, the electromagnetic energy source is a laser, the electromagnetic energy is electromagnetic energy, the electromagnetic/mechanical device is an optomechanical device and the detector is a photodetector, the system further including but not limited to a first wave guide in optical communication with the laser for coupling the laser electromagnetic energy into the optomechanical device; and a processor configured to estimate the property of the fluid from the resonant frequency spectrum. In another embodiment of the method, the optomechanical device is selected from a group of optomechanical devices consisting of a microtoroid and a zipper cavity, the system further including but not limited to a second wave guide in optical communication with photodetector for receiving electromagnetic energy from the optomechanical device. In another embodiment of the system, the swept frequency is centered around a resonant frequency for which the downhole fluid behaves as a Newtonian fluid. In another embodiment of the system, the swept frequency is on the order of 20 kilo hertz. In another embodiment of the system, the property is selected from a group consisting of viscosity and density of the fluid.

The foregoing examples of illustrative embodiments are for purposes of example only and are not intended to limit the scope of the invention.

What is claimed is:

1. An apparatus for estimating a property of a downhole fluid, the apparatus comprising:
a test cell that receives the downhole fluid;
a swept frequency electromagnetic energy source that emits electromagnetic energy toward the downhole fluid in the test cell;
an electromagnetic/mechanical device that is immersed in the fluid and receives the emitted electromagnetic energy, wherein the emitted electromagnetic energy being emitted is swept about a resonant frequency for the electromagnetic/mechanical device; and
an electromagnetic energy detector in electromagnetic communication with the electromagnetic/mechanical device immersed in the fluid, the electromagnetic energy detector producing an output signal indicative of the downhole fluid property.

2. The apparatus of claim 1, wherein the electromagnetic energy source is a laser, the electromagnetic/mechanical device is an optomechanical device and the electromagnetic energy detector is a photodetector, apparatus further comprising:
a first wave guide in optical communication with the laser for coupling the laser electromagnetic energy into and out of the optomechanical device.

3. The apparatus of claim 2, the apparatus further comprising:
a second wave guide in optical communication with photodetector for receiving electromagnetic energy from the optomechanical device, wherein the processor is configured to estimate the property of the fluid from an amplitude of electromagnetic energy received from the optomechanical device versus the swept frequency.

4. The apparatus of claim 2, wherein the optomechanical device is selected from at least one of a microtoroid and a zipper cavity.

5. The apparatus of claim 2, wherein the swept frequency of electromagnetic energy emitted by the laser is substantially centered on a resonant frequency for the optomechanical device wherein the downhole fluid behaves as a Newtonian fluid.

6. The apparatus of claim 5, wherein the optomechanical device is fabricated in a size selected to resonate at the frequency for the optomechanical device wherein the downhole fluid behaves as a Newtonian fluid.

7. The apparatus of claim 2, wherein the property is selected from a group consisting of viscosity and density of the fluid.

8. The apparatus of claim 2, wherein the laser electromagnetic energy introduced into the electromechanical device further comprises a first and second frequency of electromagnetic energy, wherein the first frequency of electromagnetic energy is swept around the resonant frequency and the second frequency of electromagnetic energy is coupled the photodetector and analyzed determine the resonant spectrum optomechanical device.

9. The apparatus of claim 1, wherein the fluid is electrically conductive.

10. The apparatus of claim 2, wherein the laser and photodetector are located outside of the test cell, the apparatus further comprising:
a window in a wall of the test for ingress and egress of the electromagnetic energy to and from the optomechanical device immersed in the fluid.

11. A method for estimating a property of a downhole fluid, the method comprising:
capturing downhole fluid in a test cell;
immersing an electromagnetic/mechanical device in the downhole fluid in the test cell;
introducing electromagnetic energy into the electromagnetic/mechanical device;
sweeping the electromagnetic energy at a frequency range around a resonant frequency for the electromagnetic/mechanical device;
measuring electromagnetic energy from the electromagnetic/mechanical device over the swept frequency range;
determining resonance spectrum values for the electromagnetic/mechanical device over the swept frequency range;
determining a first frequency for the swept frequency spectrum;
determining a second frequency for the swept frequency spectrum; and
estimating the property for the downhole fluid from the first and second frequencies.

12. The method of claim 11, wherein the swept frequency spectrum further comprises measured electromagnetic energy amplitude values from the electromagnetic/mechanical device and the first frequency is a frequency at which a component of the swept frequency spectrum value is at a maximum and the second frequency is a frequency at which a component of the resonance spectrum value is at a maximum value.

13. The method of claim 11, wherein the property of the fluid is selected from the group consisting of density and viscosity.

14. The method of claim 11, the method further comprising:
estimating the property of the fluid by comparing the first frequency and the second frequency to frequencies stored in a data structure wherein the data structure indicates the fluid properties associated with the first and second frequency.

15. A system for estimating a property of a downhole fluid, the system comprising:
a carrier for transporting a test cell for capturing a downhole fluid;
a plurality of test devices for analyzing the downhole fluid;
an electromagnetic/mechanical device immersed in the downhole fluid;
an electromagnetic energy source in electromagnetic communication with the electromagnetic/mechanical device;
a processor for sweeping a frequency of electromagnetic energy about a resonant frequency for the electromagnetic/mechanical device; and
a detector in electromagnetic communication with electromagnetic energy that has interacted with the electromagnetic/mechanical device immersed in the fluid.

16. The system of claim 15, wherein the electromagnetic energy source is a laser, the electromagnetic energy is electromagnetic energy, the electromagnetic/mechanical device is an optomechanical device and the detector is a photodetector, the system further comprising:
a first wave guide in optical communication with the laser for coupling the laser electromagnetic energy into the optomechanical device; and
a processor configured to estimate the property of the fluid from the resonant frequency spectrum.

17. The system of claim 16, wherein the optomechanical device is selected from a group of optomechanical devices consisting of a microtoroid and a zipper cavity, the system further comprising:
a second wave guide in optical communication with photodetector for receiving electromagnetic energy from the optomechanical device.

18. The system of claim 16, wherein the swept frequency is centered around a resonant frequency for which the downhole fluid behaves as a Newtonian fluid.

19. The system of claim 18, wherein the swept frequency is on the order of 20 kilo hertz.

20. The system of claim 16, wherein the property is selected from a group consisting of viscosity and density of the fluid.
